(19) United States
(12) Patent Application Publication
(10) Pub. No.: US 2013/0203037 A1
(43) Pub. Date: Aug. 8, 2013

(54) EXAMINATION MANGEMENT

(71) Applicants: Venguswamy Ramaswamy, Mumbai (IN); Viral Shah, Mumbai (IN)

(72) Inventors: Venguswamy Ramaswamy, Mumbai (IN); Viral Shah, Mumbai (IN)

(73) Assignee: Tata Consultancy Services Limited, Mumbai (IN)

(21) Appl. No.: 13/485,155

(22) Filed: May 31, 2012

(30) Foreign Application Priority Data
Feb. 7, 2012 (IN) 353/MUM/2012

(51) Int. Cl. G09B 7/00

(52) U.S. Cl. 434/353

(57) ABSTRACT

The present subject matter discloses a method and system (100) for conducting examination for at least one candidate. In one implementation, the method includes enrolling the at least one candidate. The method further includes managing at least one examination resource based at least on enrolling of the at least one candidate. A plurality of question papers is generated to evaluate the at least one candidate based at least on an assessment type. Furthermore, the method includes evaluating the at least one candidate based at least on the assessment type. The assessment type can be at least one of an online assessment and an offline assessment.

### TECHNICAL FIELD

The present subject matter, in general, relates to conducting examination and, in particular, relates to systems and methods for conducting examinations for candidates on a large scale.

### BACKGROUND

Developments in the field of information technology have resulted in production of fast, secure, and reliable computing and communication systems. The development has also witnessed growing need for utilizing such systems in various applications, which predominantly makes the application to be performed more efficiently, quickly, and in a manner that is organized and effective. Such applications are often used in areas that involve large scale data handling. One such application is educational assessment.

Generally, educational assessment is performed by schools, colleges, universities, governmental departments, private recruitment agencies, private institutions, private aptitude testing agencies, and so on. The type of assessment carried out may vary based on the end objective of the assessing body. The assessment can be objective in case of examinations conducted for scenarios, such as a common entrance or admissions test for gaining admission into a specialized education programme, such as a masters programme in business administration. Similarly, in certain other cases, the assessment can be subjective in nature. This can include, for example, term-based examinations conducted by a university across different locations.

Conducting such examinations involve great amounts of logistic efforts. For example, such examinations involve various stages of examination processes such as enrollment, grading, etc. that have to be coordinated with each other. Conventional systems for conducting such examinations may not be capable of conducting such examinations on a large scale. Further, entities responsible for various stages may also not be synced with each other, which may affect the overall efficiency of the examination process.

### SUMMARY

This summary is provided to introduce concepts related to systems and methods for conducting examination and the concepts are further described below in the detailed description. This summary is neither intended to identify essential features of the claimed subject matter nor is it intended for use in determining or limiting the scope of the claimed subject matter.

In one implementation, a method for conducting examination for at least one candidate is described. In one implementation, the method includes enrolling the at least one candidate. The method further includes managing at least one examination resource based at least on the enrolling of the at least one candidate. A plurality of question papers is generated to evaluate the at least one candidate based at least on an assessment type. Furthermore, the method includes evaluating the at least one candidate based at least on the assessment type. The assessment type can be at least one of an online assessment and an offline assessment.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network environment implementing a framework for managing examination processes, in accordance to an implementation of the present subject matter.

FIG. 2 illustrates an enrollment system, in accordance with an implementation of the present subject matter.

FIG. 3 illustrates an evaluation system, in accordance with an implementation of the present subject matter.

FIG. 4 illustrates a grading system, in accordance with an implementation of the present subject matter.

FIG. 5 illustrates a method for conducting examination, in accordance with an implementation of the present subject matter.

### DETAILED DESCRIPTION

Systems and methods for conducting examinations for a large number of users, such as candidates, are described. Such systems and methods can be implemented in a variety of computing devices, such as laptops, desktops, workstations, tablet-PCs, smart phones, notebooks or portable computers, tablet computers, mainframe computers, mobile computing devices, entertainment devices, computing platforms, internet appliances and similar systems. However, a person skilled in the art will comprehend that the embodiments of the present subject matter are not limited to any particular computing system, architecture or application device, as it may be adapted to take advantage of new computing system and platform as they become accessible.

As is commonly known, examinations are part of a process for educational assessment by various bodies, such as educational institutions. The basic purpose of conducting an examination is to evaluate candidates appearing for examination. The evaluation can be based on a number of factors that determines the aptitude and competencies of the candidates. Generally, examinations conducted by educational institutions may be on a small scale where students of a particular class or a particular stream appear in the examination. However, when it comes to an education board or a university, the scale may differ phenomenally as a large number of students of different schools or colleges may be appearing for the same. Furthermore, the scaling is even higher when the examinations are conducted on very large scale, such as the common aptitude test conducted by the Indian Institute of Management and the like.

Some conventional methods and systems of conducting examination are more adept at organizing and planning at a smaller scale and may face difficulties in terms of planning and management of conducting examination on large scale. Other conventional systems which may be capable of organizing examinations on a large scale may not be configured to plan for the required logistics for conducting such examinations. Examples of such logistics may include, but not limited to, infrastructure, required resources, such as personnel, etc.

The conventional methods and systems of conducting examination faced many challenges. The challenges include, for example, non-availability of test centers to simultaneously accommodate large number of candidates, limited availability of infrastructure, such as providing computers with equal configuration across different test centers to the candidates. For example, organizing and arranging for a large number of computing devices for conducting examination to large number of candidates may not be feasible.

Further, the conventional systems lack interaction and communication between various processes involved in conducting examination. Such processes include but are not limited to application stage, examination stage, evaluation stage and so on. In the absence of any communication or interaction between various stages, the manner in which such an examination is conducted may not be efficient, either in terms of cost or in terms of time required for conducting such exams.

Furthermore, the setting of question papers for conducting such examinations may also have their latencies. For example, efforts may be required to ensure that the confidentiality and the secrecy of the question papers are maintained till the time of the examination. Further, the availability of same set of questions to different students in the examination center may lead students to indulge in discussions amongst themselves during the examination.

Systems and methods for conducting examinations are described. As indicated previously, the entire examination process could include one or more stages. In one implementation, the systems may be associated for each stage and may be represented as an entire architectural framework. The framework can be implemented having one or more systems each of which may be configured to manage various stages in an examination process. In one implementation, the various stages of an examination process include the application stage, allocation stage, configuration stage, evaluation stage, result generation, and certification stage. As would be appreciated by a person skilled in the art, the examination process can include various other stages without deviating from the scope of the present subject matter.

In the application stage, an application form for registration of one or more candidates for a certain examination may be generated. The application form may be based on a configurable format. The configurable format may allow the application form designer to specify one or more parameters based on which the registration for the examination would be based. In one implementation, the registration can be based on one or more identification parameters associated with the prospective candidates. Examples of such identification parameters include, but are not limited to an International Mobile Subscriber Identity (IMSI), the Subscriber Identification Module (SIM) number of a candidate, International Mobile Equipment Identity (IMEI) number or a corresponding IP address associated with a computing device which the prospective candidate aims to use for the purpose of appearing for the examination. Once registered, the prospective candidate would be identifiable through such an identification parameter. In one implementation, the registration process can be implemented to be performed either online or in an offline manner.

Once the registration process is completed, one or more allocation plans for conducting the examination are determined as part of the allocation stage of the examination process. For example, the allocation plans may indicate the resources, hardware, and so on, that may be required for conducting the examination. As will be appreciated by a person skilled in the art, the allocation plans may be based on the number of candidates that may have registered for the examination, under consideration. Once the allocation plans have been obtained, various communications can be sent to the candidates indicating number of information, such as location of the test centers, roll number, date and time of examination, etc. In an implementation, the allocation stage includes sending a link containing an application that can be installed and enabled on the candidate's mobile device to determine whether the device which is to be utilized by the candidate fulfills the necessary technical requirements for taking such an examination. For example, a check can be performed to determine whether the candidate's mobile device fulfills the necessary technical requirements for being used in such examinations.

The examination can be held either in an online or an offline manner. For the former, the questions can be provided to the candidate on a display device. Along with the questions, a plurality of options may also be provided, wherein one of the plurality of options is the likely answer to the associated question. The online assessment of the candidates requires the candidates to select right answer based on the plurality of options provided against each question. In case the examinations are conducted offline, the candidates may be handed over a question paper in a printed format, based on which the candidates may answer the questions on answer sheets. For either of scenarios, a question paper is generated. In one implementation, the questions of the question paper can be obtained from a repository of questions or a question bank. In case the examination is conducted offline, i.e., question paper is to be generated before hand, the same can be subsequently printed and made available to the candidates at the time of the examinations. In case the questions are to be generated at the time of examination, such as for an online assessment, the questions can be fetched from the question bank and provided to the candidate. In one implementation, the questions can be fetched based on one or more predefined rules. For example, the questions being provided to candidates may be different across different centers, may be in different languages and so on.

Once the questions have been attempted by the candidates, the answers provided by the candidates are evaluated and the scores for each of the candidates are generated. The score can be evaluated either manually or can be obtained electronically. In one implementation, the scores can be determined based on one or more rules or predefined answers.

The scores of the candidates can then be analyzed for generating the results. The results can be presented to the candidates in different formats. In one implementation, the various forms of the reports may be generated for depicting the results in one or more different formats. Once the results are generated, necessary certification for the successful candidates can be provided. In one implementation, the successful candidates can be provided with certificates, either in the printed format or in electronic certificates with a digital signature verifying its authenticity.

In one implementation, communication of different types of information between various stages can be encrypted for enhancing the security of information being communicated. This would ensure that the examination process is free from tampering by elements who wish to gain success in such examinations through unfair means.

In an implementation, the online assessment can be performed end-to-end on a mobile communication device, for example, a smart phone, or a tablet, where the candidate uses the mobile device at every stage of the examination process including the evaluation stage. The mobile device can be used as an exam console and is identified by its IMEI/SIM number. In another implementation, the online assessment can be performed on a computing device, such as a laptop computer. In case of the laptop computer being used as an exam console, the identification is done using the static IP address allocated to the computer.

As will be appreciated by a person skilled in the art, the entire end-to-end examination process aims to increase the efficiency in the manner in which the examination is conducted. For example, the systems and methods as described would be able to assess before hand the resources and the hardware that would be required for conducting such an examination. Furthermore, the need for computing devices can also be addressed, as the users can appear and take the examination through their mobile device. Also, the availability of the central repository of questions ensures that the generation of question papers for candidates can be automated. Furthermore, the presence of various security measures also ensures that the confidentiality of the question paper is maintained at all stages. Still further, the framework provides for the generation of results and issuance of certificates for the successful clients. As would be gathered, the interaction between various systems pertaining to various stages of the examination process ensures greater coordination between personnel involved in such stages thereby contributing to the efficiency of the examination process. These and other aspects are provided in further detail in conjunction with the description of the accompanying figures.

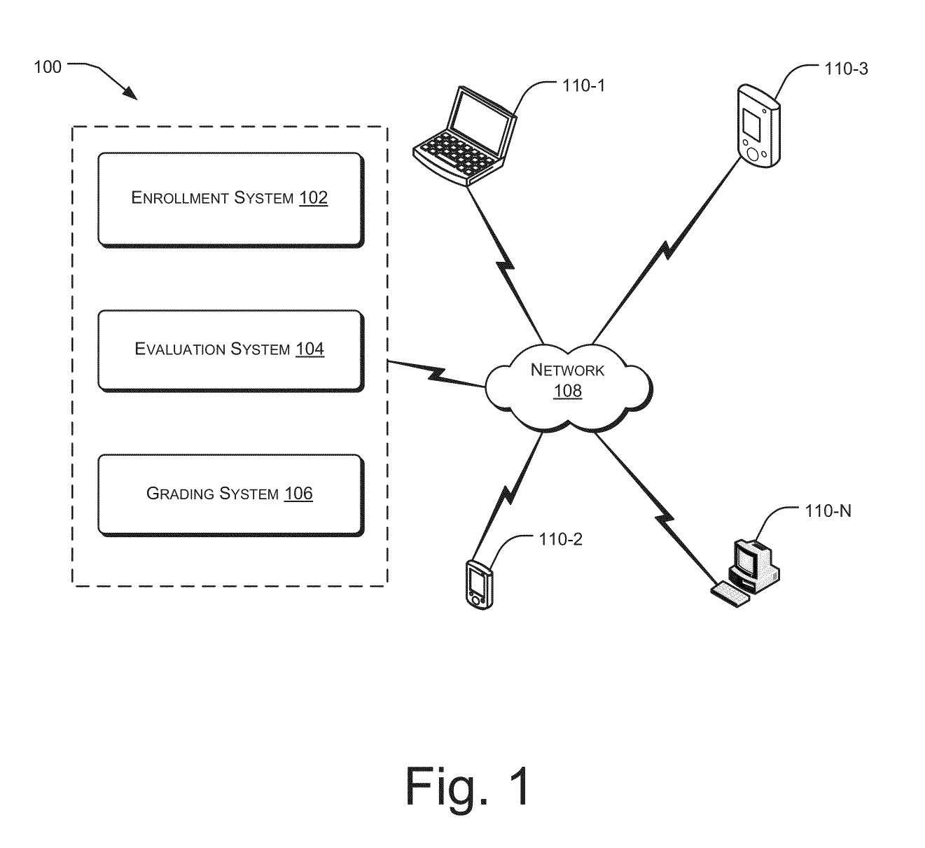

FIG. 1 illustrates a network environment 100 implementing a framework for managing examination processes, according to an implementation of the present subject matter. The network environment 100 includes an enrollment system 102, an evaluation system 104, and a grading system 106 that interact with each other. In one implementation, each of the enrollment system 102, the evaluation system 104 and the grading system 106 interact with each other via network 108. Furthermore, each of the enrollment system 102, the evaluation system 104 and the grading system 106 can be accessed by users through client devices 110 via the network 108. In an implementation, the user accesses the systems 102, 104, and 106 of the network environment 100 through one or more client devices 110-1, 110-2, 110-3 . . . 110-N (hereinafter are collectively referred to as client devices 110). In an implementation, the user can be one or more candidates, one or more prospective candidates, one or more exam administrators, and so on.

In one implementation, the systems 102, 104, and 106 can be implemented as a computing device connected to the network 108. For instance, the enrollment system 102, the evaluation system 104, and the grading system 106 may be implemented as mainframe computers, workstations, personal computers, desktop computers, multiprocessor systems, laptops, network computers, minicomputers, servers, and the like. In addition, the systems 102, 104, and 106 may include multiple servers to perform mirrored tasks for users, thereby relieving congestion or minimizing traffic. Examples of the client devices 110 include, but are not limited to personal computers, desktop computers, smart phones, PDAs, and laptops. Communication links between the client devices 110 and the enrollment system 102 are enabled through a desired form of connections, for example, via dial-up modem connections, cable links, digital subscriber lines (DSL), wireless or satellite links, or any other suitable form of communication.

Moreover, the network 108 may be a wireless network, a wired network, or a combination thereof. The network 108 can also be an individual network or a collection of many such individual networks interconnected with each other and functioning as a single large network, e.g., the internet or an intranet. The network 108 can be implemented as one of the different types of networks, such as intranet, local area network (LAN), wide area network (WAN), the internet and such. The network 108 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 108 may include network devices, such as network switches, hubs, routers, host bus adapters (HBAs), for providing a link between the systems 102, 104, and 106 and the client devices 110. The network devices within the network 108 may interact with the systems 102, 104, and 106 and the client devices 110 through communication links.

As indicated previously, the entire examination process can be considered to include various stages. For example, the examination process can be considered to include at least an application stage, allocation stage, and evaluation stage. Various other stages can also be present in addition to the above mentioned stages. Such additional stages would however be within the scope of the present subject matter.

In one implementation, the enrollment system 102 manages application stage and allocation stage. The application stage may include the process of registration and enrollment of candidates for the examination under consideration. The allocation stage may further include the enrollment system 102 determining the resources that would be required for conducting the examination. Once the enrollment and the allocation stages are complete, the next stage of the examination process is managed by the evaluation system 104.

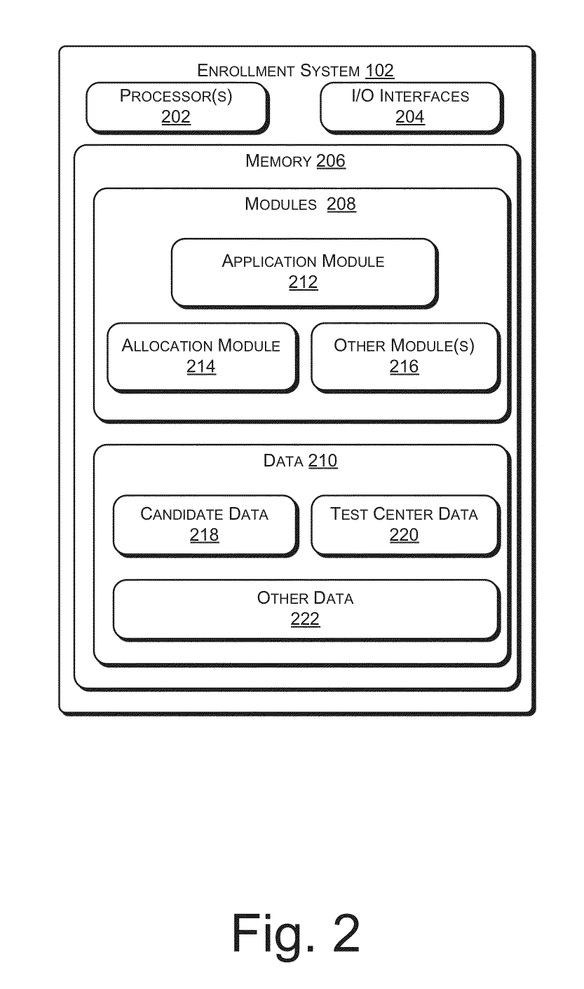

The evaluation system 104 manages and implements the generation of question papers which are required for conducting the examination. The questions provided in the question paper can be attempted by one or more candidates. The questions attempted by the candidates can then be assessed by the evaluation system 104 to determine whether the candidates have successfully cleared the examination. Once the scores of the individual candidates are obtained, the grading system 106 determines the results based on the scores of the individual candidates. The grading system 106 can further present the results in different formats say depending on the level of analysis required by the user. Based on the results, successful candidates can be issued certificates, either in the physical or an electronic form. The working of each of the modules is explained in further detail in conjunction with FIGS. 2-4.

FIG. 2 illustrates an enrollment system 102, in accordance with an implementation of the present subject matter. In one implementation, the enrollment system 102 includes a processor(s) 202, I/O interface(s) 204, and a memory 206 coupled to the processor(s) 202. The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 are configured to fetch and execute computer-readable instructions stored in the memory 206.

The interface(s) 204 may include a variety of software and hardware interfaces, for example, a web interface, a graphical user interface, etc. Further, the I/O interface(s) 204 may enable the enrollment system 102 to communicate with other computing devices, such as web servers and external data servers (not shown in figure). The I/O interface(s) 204 can facilitate multiple communications within a wide variety of networks and protocol types, including wired networks, for example, LAN, cable, etc., and wireless networks, such as WLAN, cellular, or satellite. The I/O interface(s) 204 may include one or more ports for connecting a number of devices to each other or to another server.

The memory 206 can include any computer-readable medium known in the art including, for example, volatile memory (e.g., RAM), and/or non-volatile memory (e.g., EPROM, flash memory, etc.). In one embodiment, the memory 206 includes module(s) 208 and data 210. The modules 208 further include an application module 212, an allocation module 214, and other module(s) 216. It will be appreciated that such modules may be represented as a single module or a combination of different modules. Additionally, the memory 206 further includes data 210 that serves, amongst other things, as a repository for storing data fetched processed, received and generated by one or more of the modules 208. The data 210 includes, for example, candidate data 218, test center data 220, and other data 222. In one embodiment, the data stored within data 210 can be in the form of data structures. Additionally, the aforementioned data can be organized using data models, such as relational or hierarchical data models.

As indicated previously, the examination process begins with the prospective candidates applying or enrolling through an application form. In one implementation, the application module 212 generates one or more application forms. The application module 212 may generate the application form based on one or more parameters, say provided by an administrator. The parameters that are provided by the administrator may be based on the examination for which the candidates are intending to appear. In an implementation, the application form may further request information which may be unique for a prospective candidate. For example, the application form may require the prospective candidate to provide parameters which include the International Mobile Subscriber Identity (IMSI) or the Subscriber Identification Module (SIM) number of a candidate, and e-mail address of the candidate, which are used by the exam administrator to contact the prospective candidates. Furthermore, the parameters may also be based on the qualifying criteria that may have been specified by the institution for which the examination is being conducted. For example, in some cases the institution may be requiring only past educational qualifications. In other cases, past professional qualification or personal information, such as weight, height, etc., may also be required.

Once, the application forms are generated by the application module 212 based on the one or more parameters, the application forms are made accessible to the prospective candidates either online through electronic medium, or offline in the form of a printed application form. In one implementation, the candidates enroll by completing the online application form. In an implementation, the candidates connect to the application module 212 through the network 108 from any one of the client devices 110. For instance, the candidate can connect to the application module 212 of the enrollment system 102 through internet accessed from a home desktop computer 110-1 and enroll by filling the necessary fields of the application form. In one implementation, the enrollment system 102 may further validate the details provides by the prospective candidate. For example, in order to validate the mobile number provided by the candidate, an SMS can be sent to the number provided by the candidate for purposes of validation. Similar mechanism can also be followed for validating the email address, where the user can, say by clicking a link provided in the email, can validate. Once registered or enrolled, each of the candidates can be identified by one or more of such unique identification parameters. In one implementation, the unique identification parameters associated with each of the prospective candidate can be stored in candidate data 218.

In one implementation, the application module 212 receives application forms compiled offline, for registration of the one or more candidates through a back office controlled by the exam administrator. In an implementation, the exam administrator prepares and prints a customized application form depending upon the requirements of the candidates or the type of examination so that the candidates can complete the application form offline, i.e., by manually filling the printed application form. In one implementation, the application forms can be compiled offline and uploaded electronically by the exam administrator, for example, the application forms can be compiled as electronic documents in various file formats which can then be uploaded to the application module 212. In an implementation, the candidate details recorded in the application form are stored in the data 210 as candidate data 218. In one implementation, the various file formats in which the application forms are compiled can be, for example, Microsoft Excel® file format.

In an implementation, to manage one or more examination resources based at least on the registration of one or more candidates by the application module 212, the enrollment system 102 includes the allocation module 214. The allocation module 214 enables the enrollment system 102 to manage the examination resources, for example, availability of test centers in general, availability of test centers with special features, such as Wi-Fi, and Bluetooth connectivity, availability of examination administrators who can monitor and control the conducting of the examination across different test centers, and availability of computing devices across different test centers, such as personal computers, laptops, servers, printers, and scanners. In an implementation, the allocation module 214 allocates infrastructure based on the number of candidates registered for the examination. For example, the number of test centers required to conduct the examination is determined based on the number of registered candidates. If the number of registered candidates is more, the allocation module 214 determines the number of test centers to be allocated as more, i.e. proportional to the number of registered candidates. In one implementation, the allocation module 214 includes managing nodes, i.e., identification and selection of appropriate test centers. In an implementation, the identification of appropriate test centers is carried out in two phases. First, the test center administrators are registered. For instance, the registration of test center administrators can include identifying the appropriate test centers based on prior records stored in the form of test center data 220 in the data 210. Secondly, the method involves performing capacity estimation on the available resources at the test center based on the likely number of candidates to appear from that test center. The details of the test centers identified by this two prong method are stored in the test center data 220.

Once, the registration of candidates is completed, the enrollment system 102 determines the total number of candidates actually appearing for the examination. Registration of the candidates enables the allocation module 214 to have access to candidate information, such as address of the candidate, domicile of the address of the candidate, and the likes. For example, the domicile of the candidate's address can enable the allocation module 214 to identify the appropriate test center for the candidate. In one implementation, the identified test centers are then selected to schedule the examination. Further, the allocation module 214 enables the exam administrator to view and allocate the test centers that are not selected yet based on the availability of the test centers, in case the number of candidates is more than the already selected test centers. Furthermore, the allocation module 214 includes audit module to audit the candidate data 218 and the test center data 220 stored in the data 210. The allocation module 214 includes an admission module that audits the registered candidate data 218 and enables the allocation module 214 in issuing admission cards for the appropriate candidates appearing in the examination. In one implementation, the admission cards can be issued in the form of e-admit cards, which are sent to the candidates electronically. In an implementation, the e-admit cards are generated after mapping the registered candidates to the corresponding test centers. In one implementation, the method involves allocating test centers with a buffer of approximately 5% to 10% in order to accommodate more number of candidates, which is determined by a capacity verification process performed subsequently by the allocation module 214. In one implementation, the parameters for capacity verification process are stored in the other data 222 of the data 210.

In one implementation, the device which is used by the candidate during the examination has to be validated. The validation can include determining whether the user device fulfills one or more technical requirements as specified by the examination authorities. Further, validation ensures that compatibility issues, if any, are addressed before the day on which the examination is to be conducted.

For validating the user device, in one implementation, a link for downloading an application can be sent to each of the user devices. Through the link, the user device can be checked to determine whether the candidate's user's device, say a mobile device, laptop, handheld computing device, etc., conforms to the technical requirements, as prescribed by the examination authority.

In another implementation, the device identification associated with each of the user device can be obtained. For example, the allocation module 214, for a phone, determines the International Mobile Equipment Identity (IMEI) number of the candidate's mobile device. In an implementation, the IMSI/SIM number provided by the candidate during the application stage of the enrollment system 102, and the IMEI number of the candidate's mobile device captured during the allocation stage of the enrollment system 102, uniquely identifies the candidate during the entire examination process and enables the exam administrator to validate the authenticity of the candidate at every stage of the examination process. In yet another implementation, if the user device utilized by the candidate is a computing-based device such as a laptop, or handheld computing device, the allocation module 214 may associate a static IP address with the user device under consideration. The information in relation to such device identification can also be stored in candidate data 218.

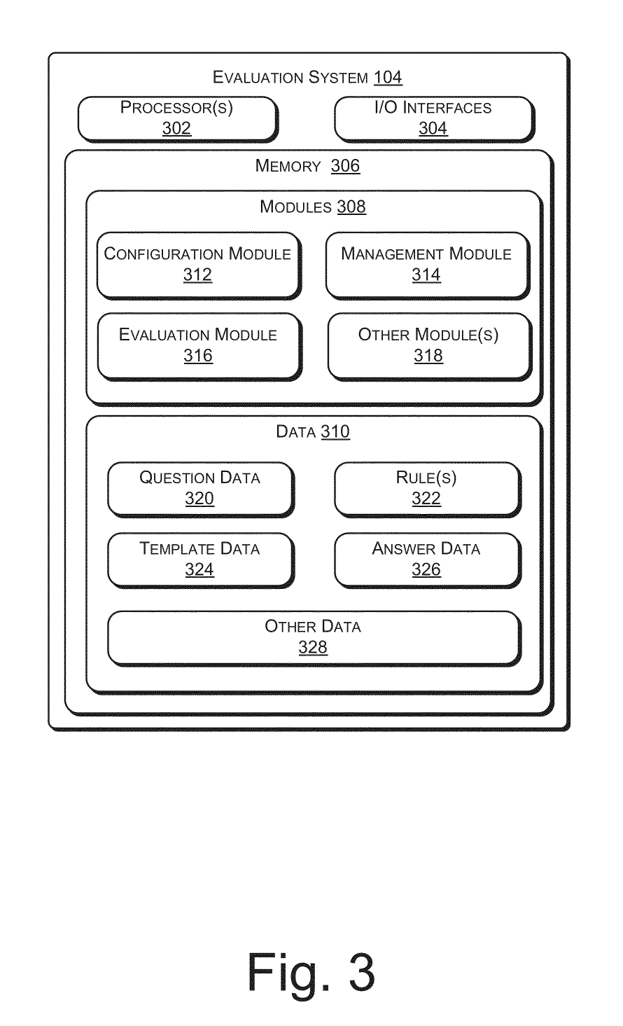

FIG. 3 illustrates the evaluation system 104, in accordance with an implementation of the present subject matter. In an implementation, the evaluation system 104 is connected to one or more client devices 110 through the network 108. In one implementation, the evaluation system 104 includes a processor(s) 302, I/O interface(s) 304, and a memory 306 coupled to the processor(s) 302. The interface(s) 304 may include a variety of software and hardware interfaces, for example, a web interface, a graphical user interface, etc., allowing the evaluation system 104 to interact with the client devices 110. The memory 306 can include any computer-readable medium known in the art including, for example, volatile memory (e.g., RAM), and/or non-volatile memory (e.g., EPROM, flash memory, etc.). In one embodiment, the memory 306 includes module(s) 308 and data 310. The modules 308 further include a configuration module 312, a management module 314, an evaluation module 316 and other module(s) 318. It will be appreciated that such modules may be represented as a single module or a combination of different modules. Additionally, the memory 306 further includes data 310 that serves, amongst other things, as a repository for storing data fetched, processed, received and generated by one or more of the modules 308. The data 310 includes, for example, question data 320, rules 322, template data 324, answer data 326, and other data 328. In one embodiment, the data stored within data 310 can be in the form of data structures. Additionally, the aforementioned data can be organized using data models, such as relational or hierarchical data models.

In an implementation, once the enrollment of candidates is successfully completed followed by the allotment of test centers based on the registered candidates, the configuration module 312 of the evaluation system 104 enables generation of question paper based on the type of examination and the type of candidates appearing in the examination. In one implementation, the configuration module 312 creates a plurality of question papers to evaluate the one or more candidates based on an assessment type. In one implementation, the configuration module 312 creates question papers based on the rules 322 stored in the data 310. In an implementation, the rules 322 are associated with questions stored in a question bank or a data repository in the question data 320.

The type of assessment based on which the configuration module 312 creates the question papers, may be, for example, an objective type of assessment, and subjective type of assessment. For objective type of assessment, objective type of question papers are prepared, similarly, for a subjective type of assessment, subjective type of question papers are prepared. In another implementation, the question papers are custom prepared based on the candidates and/or the test centers by the configuration module 312. The stored questions may be collated from various sources, such as educational institutions, researchers, and academicians. The rules 322 are used to categorize each of the questions such that the questions for a particular subject can be selected for varying difficulty levels and scores in a variety of permutations and combinations, such that each question paper is unique for a group of candidates belonging to an examination center. In an implementation, the configuration module 312 creates questions based on the type of assessment and the type of candidates appearing in the examination.

Furthermore, the configuration module 312 can generate a customized question paper based on the questions selected from the question bank stored in the form of question data 320 and pre-determined question paper templates stored in the form of template data 324. In an implementation, the configuration module 312 includes a content creator that auto generates the question papers based on the rules specified in the rules 322.

In an implementation, the generation of question papers by the configuration module 312 is adaptive in nature, i.e., the difficulty level of the questions increases as the candidate progresses through the examination. For example, if a candidate continuously receives a plurality of questions with the difficultly level of easy or medium, the configuration module 312 is adaptive to generate the next question with the difficulty level higher as compared to the question previously answered by the candidate. Similarly, if the candidate unfortunately has answered a series of question incorrectly, the configuration module 312 may provide the candidate with an easier question.

In an implementation, the configuration module 312 generates question papers with time as a configurable parameter. For example, questions in each section of the question paper or each section in the question paper can be configured distinctly based on time. Further, the configuration module 312 enables configuring the start and end time of an exam, including the option of providing additional time for a particular exam is configurable using the configuration module 312.

Furthermore, in an implementation, the configuration module 312 generates question papers on the fly, i.e. the question papers are generated by fetching questions from the question bank at run time based on the rules 322. In an implementation, if the questions are not fetched due to insufficient number of question matching the rule, the configuration module 312 generates a default question paper containing predetermined set of questions. More over, the configuration module 312 enables generation of question papers based on the level of candidates appearing in the examination.

Further, the configuration module 312 includes generating question papers of multiple disciplines and multiple languages. In one implementation, the evaluation system 104 involves conducting examinations of multiple disciplines and multiple languages simultaneously. In another implementation, the question papers generated based on the set of rules and the corresponding questions in the question papers are encrypted and securely transferred from the central server to the local server. In an implementation, the question papers are encrypted by 128 bit AES encryption. In another implementation, secure virtual private networks (VPN) are used with tunneling protocols to manage contents, such as question papers that are sent from the central server to the local server.

### Candidate Verification

In one implementation, the evaluation system 104 includes a management module 314 for managing an examination based on certain specific parameters. These parameters, for example, can include schedule of the examination, mode of examination, language in which the examination is to be conducted, subject matter or discipline of the examination and other instructions specific to the type of examination being conducted. In one implementation, the management module 314 maps the number of candidates with the available test centers and the days of examination specific to the candidates and the test centers. For example, the management module 314 can access the data with respect to the specified parameters that is stored in the other data 328 of the data 310. In an implementation, managing examination includes verification of the application number allocated to the candidate by the exam administrator, which enables the exam administrator to retrieve the complete information of the candidate appearing in the examination from the candidate data 218. In an implementation, the second of the plurality of checks is performed at this stage, where the candidate's IMEI number and the SIM number are verified by the exam administrator. In an implementation, other factors that enable the exam administrator to distinctly validate the authenticity of the candidate appearing in the examination such as biometrics of the candidate are employed as part of verification process. Further, in one implementation, the candidate's photograph, which is obtained as part of the enrollment process is used for verification. In one implementation, the candidate's photograph is displayed on the candidate's exam console to allow verification by the exam administrator invigilating the examination.

In one implementation, the management module 314 includes verifying the capabilities of the candidate's computing device, for example, a laptop 110-1. For instance, the management module 314 identifies the test centers that are allocated with candidates providing the examination from computing devices. The exam administrator of each such test center is provided access to the computing devices of the candidates prior to the day of the examination. In an implementation, the computing devices of each candidate is allocated a unique static IP address, which similar to the IMEI/SIM number of a candidate using mobile devices as the exam console, acts as a unique identifier that identifies the candidates using the computing devices as the exam console.

### Mock Assessment

In an implementation, the management module 314 further enables the evaluation system 104 to provide training to the candidates registered to appear in the examination. For example, in one implementation, the management module 314 is configured to conduct a mock assessment. In one implementation, for instance, the mock assessment is conducted in such a manner to allow the candidates to take the mock assessment from anywhere outside the test centers. For example, the candidates can appear in the mock assessments from their home personal computers. Mock assessments to familiarize the candidates with the pattern of the questions in the examination and the examination console that will be used for the real examination. In one implementation, the management module 314 allows the exam administrators to plan the assessment of candidates specific to the requirements of the candidates or to the conducting body. In an implementation, mock assessments can be of two types, viz. static mock assessment and actual mock assessment. The static mock assessment, for example, can be provided to the candidates through a static link, which when accessed by the candidates, from the mobile device or the computing device allows static rendering of the question paper and the answer sheet console. In an implementation, the link to the static mock assessments can be accessed by the candidates from anywhere, for example, the candidate's home PC or the candidate's registered mobile device that has the required capabilities for rendering of the question paper and the answer sheet console. In an implementation, the actual mock assessment can be provided to the candidates, for example, in a test center, prior to the day of the examination. In one implementation, the actual mock assessment is a practice examination, which includes assessment, evaluation and score computation similar to an actual examination.

In one implementation, the evaluation system 104 further includes the evaluation module 316 that evaluates the one or more candidates based at least on the assessment type. The assessment type can be at least one of an online assessment and an offline assessment.

### Online Assessment

The online assessment, in one implementation, can be conducted in any form of computing device by the evaluation module 316. For example, the test center conducting the examination implements a distributed architecture that hosts a local server, which can be controlled by a central server operated by the exam administrator. The local server in turn can be connected to a number of client devices 110, for instance, computers locally installed that allows the candidates to attend the examination. In one implementation, the local server can be connected to other form of client devices 110, for example, smart handheld devices, or tablets of the candidates. In an implementation, the local server is connected to the central server only at the time of downloading the question paper and answer sheet templates that are stored in the template data 324 and the other data 328 of the data 310 and during transfer of scores obtained by the candidates. In one implementation, the hand held devices 110 can be connected to the local server through known wireless or Bluetooth configurations. A distributed architecture includes several independent computers that communicate through a computer network. These computers interact with each other in order to achieve a common goal. In an implementation, the distributed nature of the online assessment enables the candidates to connect directly to the central server through the client devices 110, such as computers or handheld devices. In one implementation, the present subject matter provides a distributed architecture in which the one or more candidates connect to the central server through one or more client devices 110 that are distributed in the network environment 100. In one implementation, the distributed architecture enables online assessment of the one or more candidates to be conducted in the candidate's handheld devices while the central server that contains the various examination data associated with conducting the examination is located at a different location.

Further, in one implementation, the distributed architecture of the online assessment also enables more reliability and back up facilities. Independent back up of the central server, the local server and the candidate's devices is provided. Separate back up at each level of the distributed architecture enables the candidates to restore the examination in the event of failure at any level.

In one implementation, the online assessment is conducted on a communication device, for example, a mobile device such as a smart phone or a tablet. In another implementation, the online assessment can be conducted on a computing device, for example, a laptop computer. In the case of the mobile device, the IMEI/SIM number of the mobile device is used as a unique identifier that identifies the candidate's mobile device. In the case of the computing device, the static IP address is used as a unique identifier that identifies the candidate's laptop. The evaluation module 316, in an implementation, allows rendering of question paper in the candidate's mobile device after verification of the candidate. In an implementation, the evaluation module 316 downloads the answer sheet from the central server in a suitable format that can be rendered in any mobile device. In one implementation, upon verifying the login credentials of the candidate, the answer sheets are downloaded from the central server in an XML format. In an implementation, the answer sheets are generated in the central server based on the candidate, for example, the number of questions to be answered, the number of questions in each section, the number and type of options available as answers for each questions can vary for each candidate. In an implementation, the evaluation module 316 allows dynamic rendering of the answer sheets on the mobile device and enables the candidates to switch between the questions in both forward and backward directions. In one implementation, the online assessment involves providing questions to the candidates based on the answering pattern, for example, a plurality of correct answers provided by the candidate can automatically generate a question with higher difficulty level.

In an implementation, the evaluation module 316 further includes evaluating the online based assessment to generate scores based on the answers provided by the candidates in the examination. The generated scores are securely transferred from the local server to the central server so that the results are not tampered with.

In an implementation, the answers of candidates appearing in the online based assessment are evaluated automatically online. In an implementation, to automatically evaluate the online assessment, the evaluation module 316 includes online evaluation of the answers based on the predetermined answer keys stored in the form of other data 328 in the data 310. In an implementation, the answers provided by the candidates in the online assessment are stored in the answer data 326.

### Offline Assessment

In one implementation, the evaluation module 316 further enables offline based assessment, which involves subjective assessment of the candidates. In one implementation, for example, the candidates are provided with a printed question paper that is prepared based on specific rules 322 by the exam administrator or the invigilator. In an implementation, the offline assessment enable the generation of the question papers by the configuration module 312 based on the rules 322 that are given as printed hand-outs to the candidates. In an implementation, the evaluation module 316 allows the candidates to manually answer the questions on an answer book, which is later scanned for further evaluation. In another implementation, the evaluation module 316 allows the candidates to answer the questions electronically through any digital media that contains the answer sheet template. This implementation is called as a hybrid assessment mode. The hybrid assessment mode enables the candidates to answer through the mobile device or the computing device for the question papers that are given to them as printed hand-outs. In one implementation, the answer books given to the candidates are based on the type of questions, mode of question paper and the order of questions in the generated question paper. In an implementation, the offline assessment includes candidates answering based on the question paper generated from the configuration module 312, which are evaluated manually by the assessing exam administrators.

### On-Screen Marking

The offline assessment includes evaluating the answers provided by the candidates in the answer books. In an implementation, the offline assessment includes generation of question paper based on the specified rules by the configuration module 312 and on-screen marking of the answer books. In another implementation, the offline assessment includes candidates answering based on the physical question papers that are prepared prior to the day of the examination in the answer books provided to them, which are screened online for evaluation. In one implementation, the on-screen marking of the offline assessment includes scanning the answer books for evaluating the answers provided by the candidates. In an implementation, the on-screen marking includes evaluating the answers in the scanned answer books based on the answer keys provided in the rules 322.

In an implementation, the answers in the scanned answer books are stored in the form of answer data 326 in the data 310. In an implementation, the evaluation module 316 further includes evaluating the offline assessment to generate scores based on the answers provided by the candidates in the examination. The generated scores are securely transferred from the local server to the central server so that the results are not tampered with. In an implementation, the scores are encrypted before transferring from the local server to the central server. In one implementation the scores are encrypted using 128 bit advanced encrypted standard (AES) algorithm. In another embodiment, encryption can be done using VPN tunneling.

### Anti-Cheating Mechanism

The online assessment and the hybrid assessment mode that enables the candidates to answer through the mobile device or the computing device requires measures to curb any uncalled malpractices such as communicating with other candidates through mobile network or through internet, or intranet facilities. In an implementation, examination can also include preventing candidates from accessing internet, which is a wide source of knowledge that is readily available. In order to enable the exam administrators to curb malpractices by the candidates, the evaluation system 104 includes anti-cheating mechanism provided in the form of other modules 318.

In an implementation, the anti-cheating mechanism includes jamming the mobile network by the mobile service providers for a particular period of time, preferably for the period of examination. In another implementation, the anti-cheating mechanism includes the candidates following pre-determined steps to disable the mobile network from the mobile devices that are used as exam consoles. In an embodiment, upon the start of the examination, the anti-cheating mechanism includes closing of the other active windows in the mobile device that is used as the exam console. In one implementation, the assessment window is temporarily locked when he/she attempts to access windows other than the exam console, which can be unlocked by assistance from the exam administrator. In another implementation, the assessment window of the candidate is permanently locked when he/she attempts to access windows other than the exam console and did not contact the exam administrator for a pre-determined period of time, which for instance, can be effectively used to curb malpractices by the candidates.

In an implementation, before the start of the examination, the IMEI/SIM number of the candidates appearing in the assessment from the mobile devices are verified by the exam administrators based on the application number provided by the candidates. Based on the application number of the candidates, the exam administrator or the invigilator verifies the details of the candidates such as the name, address, the registered IMEI/SIM number of the candidate, photograph, and bio-metrics of the candidate. The verification process acts as an anti-cheating mechanism prior to the start of the examination. In an implementation, the verification process enables the candidates to use a mobile device with different IMEI number or SIM number, different from the registered mobile device, subject to approval by the exam administrator. In one implementation, the anti-cheating mechanism also includes locking of the keyboard of the computing device or the keypad of the handheld device during the online assessment to avoid any kind of malpractice.

### Crash Recovery

The online assessment enables the candidates to provide answers in their exam console to the questions generated based on the specified rules. In extreme scenarios, the examination can be interrupted by factors that are outside the control of the candidate. For example, in an implementation, the examination can be interrupted when the mobile device or the computing device used by the candidate as the exam console crashes. In another implementation, the examination can be interrupted when the local server hosting the examination crashes. In yet another implementation, the examination can also be interrupted when the central server that controls the entire examination crashes.

In an implementation, the crash recovery is done by the other modules 318 of the evaluation system 104. For example, the answers provided by the candidates are stored in the memory 306 of the evaluation system 104. In an implementation, the answers are also stored in an auto backup memory after every pre-determined period of time, for example, after every five minutes.

In an implementation, on the occurrence of crash, the auto backup taken after every pre-determined period of time allows the candidates to continue from the point of interruption of the examination. In one implementation, the answers provided by the candidates are consistently stored in the memory 306 of the evaluation system 104 allowing the candidate to login from a different machine upon crash, as the answers are stored in the server. In an implementation, the logging in from different machines is enabled by tracking a participant identification number that is generated when the candidate logs into the exam console for the first time.

In an implementation, when the server crashes, an auto backup file that stores the answers at every pre-determined period of time allows the server to completely restore from the point where it crashed. In an implementation, a backup server can be used to continuously backup the data from the central sever, and in the event of a crash of the central server, can be used as a server to continue the examination without interruption.

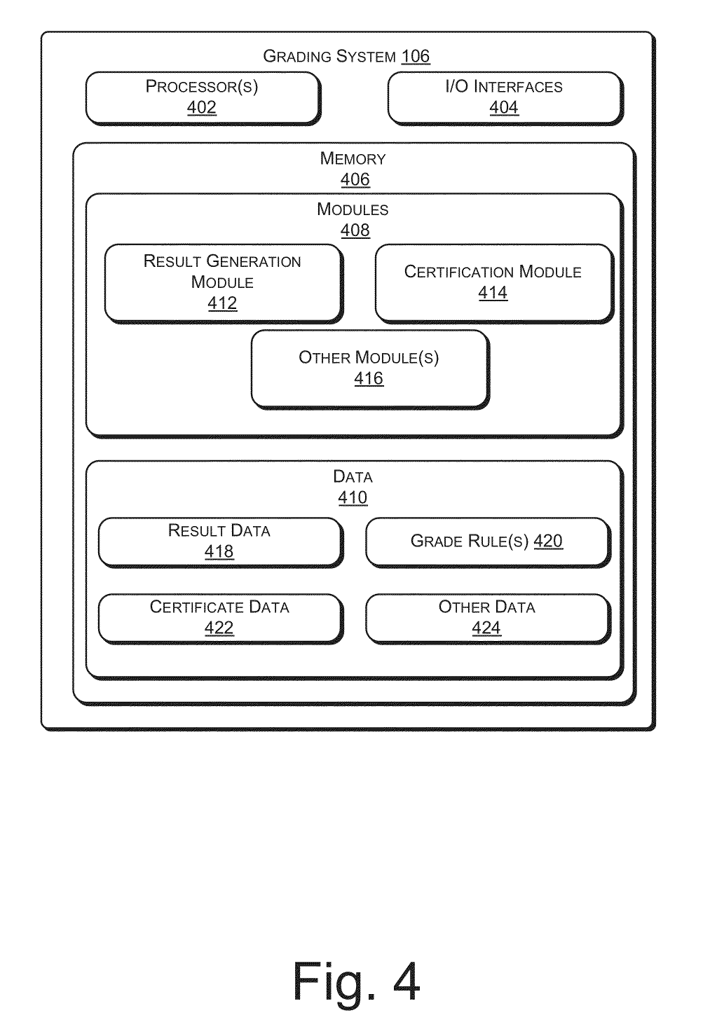

FIG. 4 illustrates a grading system 106, in accordance with an implementation of the present subject matter. In one implementation, the grading system 106 includes a processor(s) 402, I/O interface(s) 404, and a memory 406 coupled to the processor(s) 402. The memory 406 can include any computer-readable medium known in the art including, for example, volatile memory (e.g., RAM), and/or non-volatile memory (e.g., EPROM, flash memory, etc.). In one embodiment, the memory 406 includes module(s) 408 and data 410. The modules 408 further include a result generation module 412, a certification module 414, and other module(s) 416. It will be appreciated that such modules may be represented as a single module or a combination of different modules. Additionally, the memory 406 includes data 410 that serves, amongst other things, as a repository for storing data fetched processed, received and generated by one or more of the modules 408. The data 410 includes, for example, result data 418, grade rules 420, certificate data 422, and other data 424. In one embodiment, the data stored within data 410 can be in the form of data structures. Additionally, the aforementioned data can be organized using data models, such as relational or hierarchical data models.

In one implementation, the grading system 106 includes the result generation module 412 to generate results based on the scores received from evaluation system 104. For instance, the scores of the candidates who have appeared in the examination are securely transferred from the examination centers and are received by the result generation module 412 of the grading system 106. The result generation module 412, in one implementation, generates the results based on the scores obtained by each candidate and stores the same in the result data 418.

In one implementation, the results are generated based on one or more grade rules 420 stored in the data 410. Once the results are generated, the same are published for access on websites hosted by the examination conducting bodies. In another implementation, the results can be sent electronically to the candidates based on the details fetched from the candidate data 218. In one implementation, the result generation module 412 involves analysis of the results based on the grade rules 420. For example, the analysis may involve generating results based on geographic regions, comparative trends based on previous years' scores, etc.

Further, based on the results generated by the result generation module 412, the certification module 414 generates certificates to the candidates. In one implementation, the certification module 414 involves standardizing certification of the candidates based on the conducted examination and one or more certificate templates. The certificate templates can be stored in certificate data 422. Depending on the examination taken by the candidate, the appropriate template can be selected and the certificate generated. In one implementation, the certification module 414 stores the generated certificates in the certificate data 422. The certificates can be stored in case the candidates request for duplicate or additional copies of their certificates for their use.

In a further implementation, the certification module 414 generates smart degree for the candidates, which can be accessed anywhere and which is easily accessible using any operating system. For example, the smart degree akin to a digital signature, generated by the certification module 414 can contain details of the candidates, particulars of the results obtained by the candidate in the conducted examination. Such information may be present in an encrypted form for providing a security layer to prevent any tampering. In one implementation, the smart degree allows the examination conducting body and other institutions to access the particulars and validate the credibility of the certificate.

In an implementation, each stage of the entire end-to-end examination process, which includes the application stage, the allocation stage, the question paper generation stage, the assessment stage, the evaluation stage, the result generation stage, and the certification stage, is capable of being independently implemented. This enables the exam administrator to start and end at any stage without having to receive content from the other stage. In another implementation, the stages of the entire end-to-end examination process can be implemented as being mutually dependent on each other and allowing the exam administrator to utilize the entire lifecycle of the examination process.

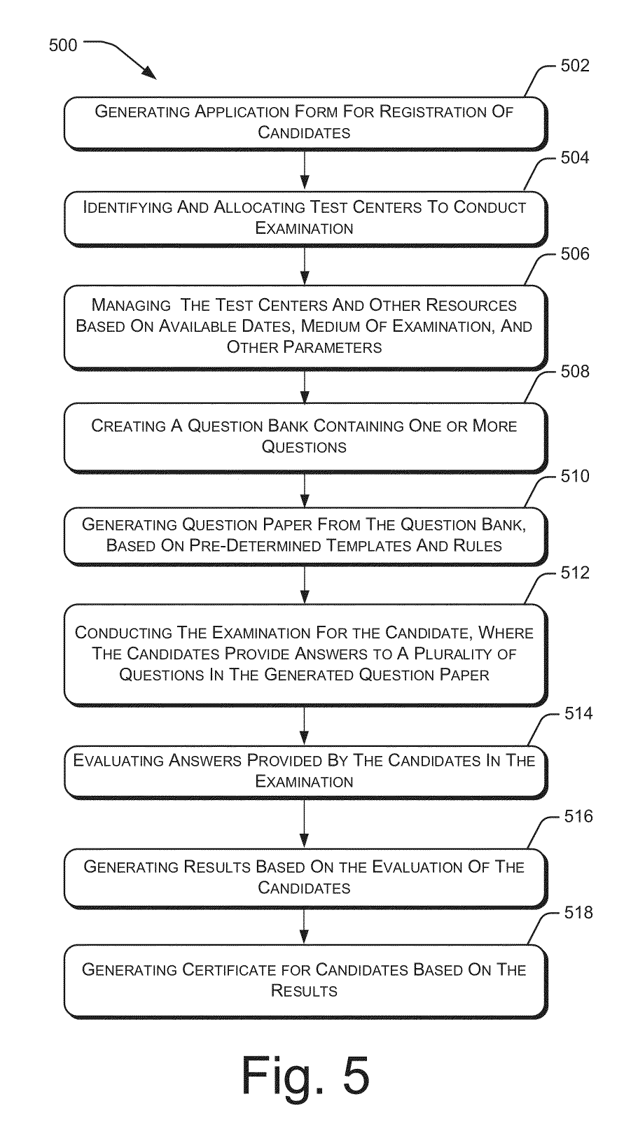

FIG. 5 illustrates a method for conducting examination, in accordance with an implementation of the present subject matter. The exemplary method 500 may be described in the general context of computer executable instructions. Generally, computer executable instructions can include routines, programs, objects, components, data structures, procedures, modules, functions, and the like that perform particular functions or implement particular abstract data types. The method may also be practiced in a distributed computing environment where functions are performed by remote processing devices that are linked through a communication network. In a distributed computing environment, computer executable instructions may be located in both local and remote computer storage media, including memory storage devices.

The order in which the method is described is not intended to be construed as a limitation, and any number of the described method blocks can be combined in any order to implement the method, or alternate methods. Additionally, individual blocks may be deleted from the method without departing from the spirit and scope of the subject matter described herein. Furthermore, the method can be implemented in any suitable hardware, software, firmware, or combination thereof. The method described herein is with reference to the enrollment system 102, the evaluation system 104, and the grading system 106 and in the context of conducting examination. Furthermore, the method can be implemented in other similar systems albeit and in other organizations with a few variations as will be best understood by a person skilled in the art.

At block 502, application form for registration of a candidate in an examination is generated. The generated application forms can then be provided to the prospective candidates, and from whom the applications are subsequently received. In an implementation, the application module 212 generates one or more application forms. The generated application forms are then subsequently made available to the candidates. The candidates can complete the application forms in an offline or an online mode. In case the application form is filled in, in an offline mode, the filled application form can be subsequently uploaded. A number of candidate-related information can subsequently be gathered from the uploaded application form. A configurable form builder is provided, which enables the generation of application form that enables the candidates to compile the details online and register for the examination. In one implementation, the application form can be generated by an exam administrator who may create the application form using various customization options.

At block 504, various resources for conducting the examination are identified and allocated. In an implementation, the allocation module 214 identifies the test centers and other resources. Based on the applications received from the candidates at block 502, the test centers are identified. The test centers are identified based on a number of factors, such as availability of test centers in general, availability of test centers with special features, such as Wi-Fi, and Bluetooth connectivity, availability of examination administrators who can monitor and control the conducting of the examination across different test centers, and availability of computing devices across different test centers such as personal computers, laptops, servers, printers, and scanners. Identification of appropriate test centers are carried out in two phase. First, the test center administrators are registered. Secondly, capacity estimation on the available resources at the test center is performed based on the likely number of candidates to appear from that test center. The test centers are allocated for conducting examination. In an implementation, the allocation module 214 allocates the test centers. The identified test centers are selected for conducting the examination. Further, the test centers that are not selected yet are identified and allocated based on the availability of the test centers and when the number of candidates is more than the already selected test centers. The test centers are allocated based on the auditing of the registered candidates and issuing admission cards for the appropriate candidates appearing in the examination. The admission cards can be issued in the form of e-admit cards, which are sent to the candidates electronically. Further, the test centers are allocated based on one or more rules, for example, with a buffer of approximately 5 to 10% in order to accommodate more number of candidates, which is determined by a capacity verification process performed subsequently.

At block 506, the allocation of test centers and resources done earlier, say at block 504, is managed. For example, the candidates appearing in the examination are mapped to test centers based on the available dates, medium of examination, and other parameters. In one implementation, the management module 314 manages the allocation of test centers and other resources. In one implementation, for example, managing the other resources can include managing the allocation of invigilators across different test centers for monitoring the examination.

In one implementation, training can be provided to the candidates appearing for the examination through mock assessments. In one implementation, the management module 314 conducts training to the candidates. Training is provided to the candidates registered to appear in the examination by conducting a mock assessment. The mock assessment is conducted in such a manner to allow the candidates to take the mock assessment from anywhere outside the test centers. For example, the candidates can appear in the mock assessments from their home personal computers. Mock assessments allow the candidates to get used to the pattern of the questions in the examination and the examination console that will be used for the real examination.

At block 508, a question bank containing one or more questions relevant for the examination to be conducted is created. In one implementation, the configuration module 312 creates the question bank. The questions stored in the question bank may be accumulated from various sources, such as educational institutions, researchers, and academicians. In one implementation, the configuration module 312 may be further configured to generate questions to be includes the question paper. A plurality of questions is generated to evaluate the one or more candidates based on a type of the assessment question required. For example, for an objective type of assessment, objective type of questions with appropriate options for candidates to choose from, are prepared. Similarly, for a subjective type of assessment, subjective type of questions is prepared.

At block 510, question papers are generated from the question bank. In an implementation, the configuration module 312 generates question papers. The rules are used to categorize each of the questions based on which the questions are selected during generation of the question paper. In another implementation, the question paper can be generated based on predetermined templates and rules stored in the rules data 322.

At block 512, examination is conducted for the one or more candidates at the one or more selected test centers. In one implementation, the evaluation module 316 enables conducting of the examination. The examination to the candidates can be conducted based on the assessment type. The assessment type can be at least one of an online assessment and an offline assessment.

An online assessment is conducted to the one or more candidates appearing for the examination. In one implementation, the evaluation module 316 conducts the online assessment. The online assessment can be conducted in any form of digital media. For example, the test center conducting the examination can host a local server, which can be controlled by a central server operated by the exam administrator. The local server in turn can be connected to a number of computers locally installed that allows the candidates to attend the examination. The online assessment can also be conducted by connecting to the local server through other form of digital media, for example, smart handheld devices of the candidates. The local server is connected to the central server only at the time of downloading the question paper and answer sheet templates and during transfer of results. The hand held devices can be connected to the local server through known wireless or Bluetooth configurations.

An offline assessment is conducted to the one or more candidates appearing for the examination. In one implementation, the evaluation module 316 conducts the offline assessment. The offline assessment can involve subjective assessment of the candidates. For example, the candidates are provided with a printed question paper that is prepared based on specific rules set by the exam administrator. The candidates manually answer the questions on an answer book, which is later scanned for further evaluation. The candidates can also answer the questions electronically through any digital media that contains the answer template.

At block 514, the answers of candidates appearing in the online based assessment are evaluated online. In an implementation, the online based assessment of the answers involves automatically evaluating the answers. Upon evaluation, the scores are generated based on the answers provided by the candidates in the online assessment.

In an implementation, the candidates provide the answers in answer books as part of the offline assessment. The answer books are scanned for evaluating the answers provided by the candidates. The answer books of the candidates appearing in the offline assessment are scanned and evaluated based on the keys stored in the other data 328 and scores for each candidate appeared in the offline assessment is generated.

At block 516, the results are generated. In one implementation, the result generation module 412 generates the results. These results are generated based on the scores received as a result of the online and offline assessments. The results are generated by comparing the scores with the grade rules 420. The generated results are either published in websites hosted by the examination conducting bodies or sent electronically to the candidates based on the details fetched from the candidate data 218. The results are analyzed to assign ranks to the candidates. The results are also capable of being re-evaluated.

At block 518, certificate for candidates based on the results generated at block 516, is generated. In one implementation, the certification module 414 generates the certificates. Smart degree for the candidates appearing the examination can be generated that can be accessed anywhere and which is easily accessible using any operating system. For example, the smart degree generated can contain details of the candidates, particulars of the results obtained by the candidate in the conducted examination. The smart degree allows the examination conducting body and other institutions to access the particulars and validate the credibility of the certificate.

Although implementations of conducting examination have been described in language specific to structural features and/or methods, it is to be understood that the present subject matter is not necessarily limited to the specific features or methods described. Rather, the specific features and methods are disclosed as implementations for conducting examination.

I/We claim:

1. A computer implemented method for conducting an examination for at least one candidate comprising:
enrolling the at least one candidate by requesting for at least one detail associated with the at least one candidate;
managing at least one examination resources based at least on the enrolling of the at least one candidate;
generating a plurality of question papers to evaluate the at least one candidate based at least on an assessment type; and
evaluating the at least one candidate based at least on the assessment type, wherein the assessment type is at least one of an online assessment and an offline assessment.

2. The method of claim 1, wherein the managing further comprises:
determining test centers for conducting the examination based on the at least one detail associated with the at least one candidate;
performing capacity planning and verification based on at least one of the determined test centers and the at least one detail associated with the at least one candidate; and
issuing admit cards to the at least one candidate based on at least one of the determined test centers and the candidate information.

3. The method of claim 1, wherein the method further comprises:
conducting the offline assessment for the at least one candidate through at least one printed question paper.

4. The method of claim 1, wherein the method further comprises:
conducting the online assessment to the at least one candidate through digitally evaluating answers provided by the at least one candidate to a plurality of questions contained in the plurality of question papers.

5. The method of claim 3, wherein the method further comprises:
scanning an answer book submitted by the at least one candidate in response to the at least one question paper; and
evaluating the scanned answer book.

6. The method of claim 1, wherein the managing further comprises planning and identifying parameters for conducting the examination, wherein the parameters includes at least one of day of conducting the examination, language of conducting the examination, availability of test center, and availability of examination dates.

7. The method of claim 1, wherein the managing further comprises conducting a mock examination for the plurality of candidates.

8. The method of claim 1, wherein the method further comprises generating results for the online assessment and the offline assessment.

9. The method of claim 8, wherein the method further comprises issuing a certification based on the results.

10. A system for conducting an examination to evaluate at least one candidate, the system comprising:
an enrollment system for managing enrollment and allocation of resources for conducting examination for the at least one candidate;
an evaluation system for managing the examination conducted for the at least one candidate enrolled through the enrollment system, the evaluation system comprising:
a processor;
a memory coupled to the processor, wherein the memory comprises:
a configuration module configured to generate a plurality of question papers based at least on an assessment type; and
an evaluation module configured to evaluate the at least one candidate based at least on the assessment type, wherein the assessment type can be at least one of an online assessment and an offline assessment; and
a grading system for grading the at least one candidate based on the examination conducted for the at least one candidate.

11. The system of claim 10, wherein the enrollment system comprises:
a processor;
a memory coupled to the processor, wherein the memory comprises:
an application module configured to generate an application form for registration of the at least one candidate; and
an allocation module configured to manage at least one examination resource based at least on the registration of the at least one candidate.

12. The system of claim 10, wherein the grading system comprising:
a processor;
a memory coupled to the processor, wherein the memory comprises:
a result generation module configured to generate results based on scores obtained by the at least one candidate in at least one of the online assessment and the offline assessment; and
a certification module configured to generate at least one certificate based on the generated results.

13. The system of claim 10, wherein the evaluation module is further configured to receive at least one answer provided by the at least one candidate in response to at least one question of the plurality of question papers.

14. The system of claim 13, wherein the at least one candidate provide the at least one answer from at least one of a personal computer in a test center, a laptop computer, and a hand held device of the at least one candidate for an assessment type being the online assessment.

15. The system of claim 11, wherein the allocation module is further configured to register the at least one candidate based on at least one identification parameter of at least one client device of the at least one candidate, wherein the identification parameter can be any one of an International Mobile Subscriber Identity (IMSI), a Subscriber Identification Module (SIM) number, an International Mobile Equipment Identity (IMEI) number, and a static IP address.

16. The system of claim 15, wherein the allocation module is further configured to determine configuration settings for conducting examination on the at least one client device.

17. The system of claim 10, wherein the management module is further configured to verify the at least one candidate based on at least one identification parameter of at least one client device of the at least one candidate, wherein the identification parameter can be any one of an International Mobile Subscriber Identity (IMSI), a Subscriber Identification Module (SIM) number, an International Mobile Equipment Identity (IMEI) number, and a static IP address.

18. The system of claim 10, wherein the configuration module is further configured to securely transfer the plurality of question papers from at least one of the enrollment system, and the evaluation system to at least one of a personal computer in a test center, a laptop computer, and a hand held device of the at least one candidate for an assessment type being the online assessment.

19. The system of claim 10, wherein the plurality of question papers are stored in an encrypted form.

20. A computer-readable medium having computer-executable instructions that when executed perform acts comprising:
enrolling the at least one candidate by requesting for at least one detail associated with the at least one candidate;
managing at least one examination resources based at least on the enrolling of the at least one candidate;
generating a plurality of question papers to evaluate the at least one candidate based at least on an assessment type; and
evaluating the at least one candidate based at least on the assessment type, wherein the assessment type is at least one of an online assessment and an offline assessment.
